(19) United States
(12) Patent Application Publication
(10) Pub. No.: US 2004/0146108 A1
(43) Pub. Date: Jul. 29, 2004

(54) MPEG-II video encoder chip design

(76) Inventor: Shih-Chang Hsia, Zhang Hua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/348,973

(22) Filed: Jan. 23, 2003

(51) Int. Cl. H04N 7/12

(52) U.S. Cl. 375/240.16; 348/700; 375/240.12; 375/240.03; 375/240.24

(57) ABSTRACT

This invention advises a new rate control scheme to increase the coding efficiency for MPEG systems. Instead of using a static GOP (Group of Picture) structure, we present an adaptive GOP structure that uses more P- and B-frame coding, while the temporal correlation among the video frames maintains high. When there is a scene change, we immediately insert Intra-mode coding to reduce the prediction error. Moreover, an enhanced prediction frame is used to improve the coding quality in the adaptive GOP. This rate control algorithm can both achieve better coding efficiency and solve the scene change problem. Even if the coding bit-rate is over the pre-defined level, this coding scheme does not require re-encoding for real-time systems. For improving the coding speed and accuracy, an adaptive full-search algorithm is presented to reduce the searching complexity with a temporal correlation approach. The efficiency of the proposed full search can be promoted about 5-10 times in comparison with the conventional full search while the searching accuracy remains intact. Based on the adaptive full search algorithm, a real-time VLSI chip is regularly designed by using the module base. For MPEG-II applications, the computational kernel only uses eight processing-elements to meet the speed requirement. The processing rate of the proposed chip can achieve 53 k blocks per second to search −127˜+127 vectors, in use of only 8 k gates.

### FIELD OF THE INVENTION

The present invention relates to the video coding. The new invention system contains a novel video coding control and high efficiency motion search engine for MPEG-II system.

### BACKGROUND OF THE INVENTION

Recently the video coding systems have widely applied for digital TV, video conferencing, multimedia systems, etc.; primarily in order to reduce the bit rates. It is well known that most coding techniques will generate variable bit-rates in various video sequences. To transmit the variable rate bit stream over a fixed rate channel, a channel buffer is required. Therefore, the main purpose of the rate control algorithm is to prevent the buffer from overflowing and underflowing, and to generate a constant bit rate for targets. To regulate the fluctuation of the coding rate, we need to allocate the compressed bit of each frame by choosing a suitable quantization parameter for each macro-block. The fundamental buffer control strategy adjusts the quantizer scale according to the level of buffer utilization. When the buffer utilization is high, the quantization level should be increased accordingly The motion compensation technique has become a popular method to reduce the coding bit-rate by eliminating temporal redundancy in video sequences. This approach is adopted in various video-coding standards, such as H.263 and MPEG-II systems. For the purpose of motion compensation, there are many motion estimation methods presented. The full search algorithm exhaustively checks all candidate blocks to find the best match within a particular window, hence this method has an enormous complexity. In order to improve the searching speed, many fast searching algorithms are presented, but they result in non-optimal solutions. An increase in the coding bit rate is inevitable when these fast algorithms are employed for real coding applications. Moreover, if the chip design employs these fast algorithms, the efficiency of VLSI architecture is decreased, because of the lack of regularity. As for regular designs, VLSI implementations of motion estimations are still realized by using the full search method. However, such full search chips are not suitable for portable systems due to high-power dissipation.

### SUMMARY OF THE INVENTION

This invention advises a new rate control scheme to increase the coding efficiency for MPEG systems. Instead of using a static GOP (Group of Picture) structure, we present an adaptive GOP structure that uses more P- and B-frame coding, while the temporal correlation among the video frames maintains high. When there is a scene change, we immediately insert Intra-mode coding to reduce the prediction error. Moreover, an enhanced prediction frame is used to improve the coding quality in the adaptive GOP. This rate control algorithm can both achieve better coding efficiency and solve the scene change problem. Even if the coding bit-rate is over the pre-defined level, this coding scheme does not require re-encoding for real-time systems. For improving the coding speed and accuracy, an adaptive full-search algorithm is presented to reduce the searching complexity with a temporal correlation approach. The efficiency of the proposed full search can be promoted about 5-10 times in comparison with the conventional full search while the searching accuracy remains intact. Based on the adaptive full search algorithm, a real-time VLSI chip is regularly designed by using the module base. For MPEG-II applications, the computational kernel only uses eight processing-elements to meet the speed requirement. The processing rate of the proposed chip can achieve 53 k blocks per second to search −127˜+127 vectors, in use of only 8 k gates.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 The frame coding as scene change between (n−1)^{th} and n^{th} frames.

FIG. 2 The proposed adaptive GOP structure.

FIG. 3 The system architecture of the propose coding control chip.

FIG. 4 VLSI architecture for the high-speed full-search motion estimation.

FIG. 5 The detail PE module.

FIG. 6 Data interlace for Path 0 and Path 1 processing.

### DETAILED DESCRIPTION OF THE PREFERRED EMBODIMENT

For video coding systems, FIFO memories are generally used for regulating the coding speed between the coding kernel and the output. As coding procedure continues, the current FIFO occupation becomes

FIFO_{current}=FIFOₚᵣₑᵥᵢₒᵤₛ+(Coding_{bit}−Target_{bit}), (1)

where coding bit is the result from the current coding kernel and target bit is the constant output rate. Since the coding bit-rate may be larger or smaller than the target bit-rate, a FIFO memory is used as a regulator for balancing the coding bit-rate and the target bit-rate dynamically. Because the FIFO memory size is limited, we need to adjust the quantization level to avoid the buffer to overflow or underflow. For MPEG coding systems, the fixed GOP structure is IBBPBBPBBPBBI, where I-frame is the basic reference for P- or B-frames coding. P-frame coding uses the motion prediction from the I-frame or the previous P-frame, and B-frame coding employs the bidirectional prediction between the neighboring I-frame and P-frame, or two P-frames. Therefore the total coding bit-rate for one GOP is then the sum of the coding bits of each frame, which is

GOP_{bit-rate}=Σ(I_{bit}, P_{bit}, B_{bit}), (2)

where I_{bit}, P_{bit}, and B_{bit}, are the coding bits for the I-frame, P-frame and B-frame respectively. For MPEG systems, since its GOP structure is fixed to the IBBPBBPBBPBBI format, the coding efficiency of its P- or B-frames becomes poor for low correlation sequences due to the high prediction errors. An extreme case is that as the video sequence changes suddenly, the coded image will produce serious coding distortions. On the other hand, if the video sequence has many highly correlated frames, we can obtain better performance by applying more P- and B-frame coding. Hence the coding quality will be much better if one can compensate motions via appropriate coding, and it is particularly effective for low motion sequences. One of the effective compensation methods is the adaptive GOP (AGOP), where its structure is dynamically modified according to the correlation between frames.

The AGOP concepts are proposed as follows. First the P- and B-frames are continuously coded by the prediction mode until one of the following conditions occurs:

(i) If the buffer utilization is very low, then the I-frame will be coded to avoid the buffer underflowing.

(ii) If the video sequence changes suddenly, i.e. P(n)_{bit}>>P(n−1)_{bit} is detected, where P(i)_{bit} is the coding bit-rate for the i^{th} P-frame, then we re-encode the n^{th} frame using an I-frame coding rather than a P-frame coding.

(iii) If the accumulated error gradually becomes high, such that

$${P ( n )}_{bit} >> {\sum }_{k = - m}^{- 1} \frac{{P ( n + k )}_{bit}}{m} \qquad ( 3 )$$

The GOP structure is adaptively changed in accordance with the temporal correlation of the previous frames. If the intervening frames have high correlation, we use more prediction coding to reduce the temporal redundancy until the accumulated error becomes too large or a scene change is detected. The accumulated errors checks by mean square error.

For real-time-processing requirements, we monitor the coding condition using the Slice base in the MPEG system. First, let N be the number of Slices used in the coding system. The first N Slices bit-rate (Slice_{current}^{first}) of the current frame is then compared with the first N Slices (Sliceₚᵣₑᵥᵢₒᵤₛ^{first}) of the previous frame. In addition, let Q_{current}^{First} and Q_{current}^{First} denote the averaged quantization scales for the first N Slices of the current and the previous frames respectively. If the averaged coding bit-rates of the N Slices for the adjacent frames have changed drastically, i.e.

$${Q}_{current}^{first} \times ( \frac{{Slice}_{current}^{first}}{N} ) >> {Q}_{previous}^{first} \times ( \frac{{Slice}_{previous}^{first}}{N} ) \qquad ( 4 )$$

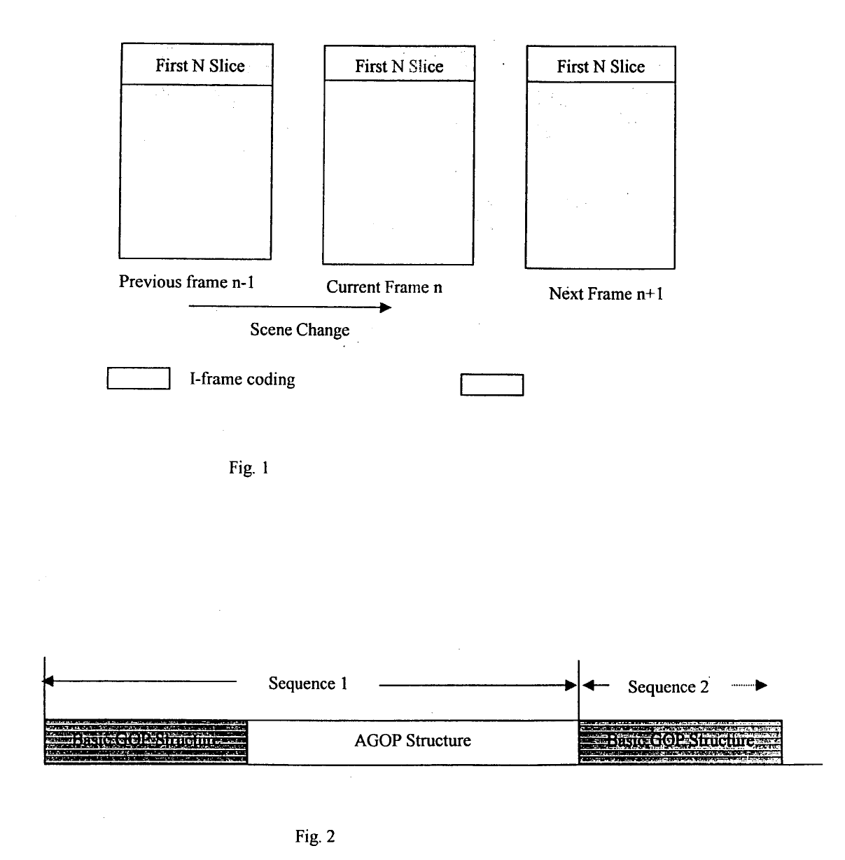

indicating that a scene change has been detected between the current frame and the previous one, then a new intra-coding is introduced to process the rest of the current frame. The same intra-coding is then used for the first N Slices of the next frame and its remaining Slices return to use the predict coding. FIG. 1 shown the detail frame coding with a scene change. The comparison begins only when both frames have P-coding in their first N Slices, and the new intra-coding is again introduced when another drastic change has been detected. Our scheme is hence efficient and fast to satisfy the needs of real-time processing. Furthermore, in our experiments, the number of N is not fixed. The first Slice coding rate is checked, the scene change is found if the coding rate of the current frame is the triple of the previous one in (4). We immediately encode I-mode for the next Slices. Otherwise, the first two Slices are checked again. With this procedure, we check the averaged coding bits from the first N Slices until to the whole frame.

Based on this concept, a new AGOP structure is presented in FIG. 2. First, the basic GOP (BGOP) structure is employed, consisting of one I frame, three P-frames and eight B-frames, where the frame order is the same as the conventional GOP structure for MPEG systems. Next an AGOP structure is applied, whose length depends on the temporal correlation. Consequently its length will be considerably shortened if a scene change is detected. In order to enhance the advantage of our new coding scheme, there is no I-frame used in the AGOP structure. We also adopt 12 frames as a coding unit to keep bit-rate balancing. The sequence order is then

PₑBBPBBPBBPBBPₑBBPBB (5)

where Pₑ is an enhanced P-frame with a higher coding bit-rate than that of a normal P-frame. We use a Pₑ-frame rather than an I-frame for high-correlated video sequences in order to reduce the temporal redundancy and the coding bit-rate. Hence the total coding efficiency is increased due to this motion compensation. The AGOP coding scheme ends when a scene change is detected or the accumulated error becomes too large, and the coding procedure then begins another BGOP processing.

It is important to note that for AGOP coding, if the correlation of local blocks is very low between two continuous frames in one sequence, high prediction errors will occur not only in the current block, but also will be transferred to the next predicted block. To overcome this drawback, we employ an intra-block coding instead of the inter-block coding for low correlation blocks in local areas. The following criterion can determine whether or not the current coding block uses an intra-block coding for P- or B-frames. If the Mean Absolute Difference (MAD)[12] from the result of motion estimation is very large, which implies that the predicted error is very serious, then an I-block coding is employed to reduce the predicted error. The coding mode for a macro-block can be determined by

$$\{ \begin{matrix}if MAD < {Th}_{0} and MV = 0 , then inter ( skip ) mode \\ Else if {Th}_{0} < MAD < {Th}_{1} , then inter ( MC + DCT ) mode \\ Else if MAD > {Th}_{1} and MV \neq 0 , then intra mode\end{matrix} \qquad ( 6 )$$

where thresholds were selected such that Th₁>Th₀ is always used. If the MAD of the motion estimation is very low and the motion vector (MV) is zero, this implies that the current block is almost the same as the referenced one. Then the referenced block can be duplicated instead of using the current block coding, so this coding block is assigned as inter(skip) mode. However, if the MAD result of the motion estimation is large, we switch from inter-mode to intra-mode to avoid high prediction errors. For fast and instantaneous real-time processing, it is necessary to evaluate the block correlation based on motion estimations first. So the coding mode for the macro block shall be selected from either the intra-mode or the inter-mode to achieve better coding quality for each local block.

First, we estimate the bit-rate for the I-frame coding. Since the I-frame is the basic reference frame, therefore its coding error would be accumulated and propagated to the next P- and B-frames. To reduce the prediction error, we must appoint higher a bit-rate for the I-frame coding. In any case, the coding bit-rate of an I-frame depends on the target rate and the frame rate of the system. Therefore the bit-rate for the I-frame must be constrained in a range of

$$\frac{Target Rate}{Frame Rate} \times {IR}_{H} \geq {I}_{bit} \geq \frac{Target Rate}{Frame Rate} \times {IR}_{L} \qquad ( 7 )$$

where IR_{H} and IR_{L} denote the maximum and the minimum factors respectively, which were determined by the buffer status of the system. As the buffer utilization is high, the coding bit-rate will be reduced accordingly. In order to control the bit-rate in the constrained range, the quantization-level for the I-frame is adaptively adjusted dependent on both the previous coding results and the buffer status.

The coding status of the system is monitored by a Slice-base method as follows. An initial quantization level is chosen for the first Slice coding as

$${Q}_{0}^{I} = \frac{{Q}_{max} + {Q}_{min}}{2} \times k \qquad ( 8 )$$

where Qₘₐₓ and Qₘᵢₙ are the maximum and the minimum quantization scale respectively, and k is a coefficient depending on the picture type. If the coding bit-rate of the n^{th} Slice is in the range of

$$( \frac{Target Rate}{NO\_Slice \times Frame Rate} ) \times {IR}_{H} \geq {Slice}_{n}^{I} \geq ( \frac{Target Rate}{NO\_Slice \times Frame Rate} ) \times {IR}_{L} \qquad ( 9 )$$

where NO_Slice is the number of Slices in one frame, there will be no change in quantization parameter. Otherwise, the quantization level is adjusted by letting

$$\{ \begin{matrix}if {Slice}_{n}^{I} \geq \frac{{IR}_{H} \times Target Rate}{No\_Slice \times Frame Rate} , & {Q}_{n + 1}^{I} = {Q}_{n}^{I} + 1 ; \\ if {Slice}_{n}^{I} \leq \frac{{IR}_{L} \times Target Rate}{No\_Slice \times Frame Rate} , & {Q}_{n + 1}^{I} = {Q}_{n}^{I} - 1 ;\end{matrix} \qquad ( 10 )$$

where Qₙ^{I} and Qₙ₊₁^{I}, denote the quantization scales for the current Slice and the next Slice respectively. If the coding bit-rate is over the pre-defined levels in the current Slice, the quantization scale is increased or deceased by one level for the next Slice in order to keep the specified bit-rate. Hence, the coding rate can keep a dynamic balance during each frame coding. The final Slice quantization scale is then recorded as an initial value for the first Slice of the next I-frame coding.

In order to prevent the buffer from overflowing or underflowing, there should be a warning system for checking buffer status. In our method, the status of the buffer occupation is not frequently extracted for quantization adjustment. When the percentage of buffer utilization P₀ falls in the range of 0.2≦P₀≦0.8, the buffer operates in normal condition and the quantization level is not adjusted. Otherwise, the quantization level will be adjusted for the next Slice coding as follows

$$\{ \begin{matrix}if {P}_{0} \geq 80 \% , & {Q}_{n + 1}^{I} = {Q}_{n}^{I} + 2 ; \\ if {P}_{0} \leq 20 \% , & {Q}_{n + 1}^{I} = {Q}_{n}^{I} - 2 ; \\ Others & {Q}_{n + 1}^{I} = {Q}_{n}^{I}\end{matrix} \qquad ( 11 )$$

From Eqs. (10) and (11), the maximum quantization scale is increased by three when the Slice coding rate is over the pre-defined level and the buffer utilization P₀≧80%. In another case, when the Slice coding is lower than the pre-defined minimum level, but P₀≧80%, we also increase the quantization scale by one for the next Slice coding.

Next, we discuss the rate control for P-frame coding. Because most of the temporal redundancy for P-frames can be removed by using motion compensations, the coding bit-rate for the P-frame is not as high as that of an I-frame. The P-frame bit-rate is then chosen close to the target bit-rate with

$$\frac{Target Rate}{Frame Rate} \times {PR}_{H} \geq {P}_{bit} \geq \frac{Target Rate}{Frame Rate} \times {PR}_{L} \qquad ( 12 )$$

where PR_{H} and PR_{L} denote the maximum and minimum control rates respectively and were usually close to unity. We also control the bit-rate for P-frame coding with Slice base, which can be expressed as

$$( \frac{Target Rate}{NO\_Slice \times Frame Rate} ) \times {PR}_{H} \geq {Slice}_{n}^{P} \geq ( \frac{Target Rate}{NO\_Slice \times Frame Rate} ) \times {PR}_{L} . \qquad ( 13 )$$

Similarly to the I-frame coding, the quantization level for each Slice of P-frame is adaptively adjusted by

$$\{ \begin{matrix}if {Slice}_{n}^{p} \geq \frac{{PR}_{H} \times Target Rate}{No\_Slice \times Frame Rate} , {Q}_{n + 1}^{p} = {Q}_{n}^{p} + 1 ; \\ if {Slice}_{n}^{p} \leq \frac{{PR}_{L} \times Target Rate}{No\_Slice \times Frame Rate} , {Q}_{n + 1}^{p} = {Q}_{n}^{p} - 1 ; \\ Others {Q}_{n + 1}^{p} = {Q}_{n}^{p}\end{matrix} \qquad ( 14 )$$

Hence during one GOP coding, the total output bit-rate is then

$${Output}_{bit - rate} = \frac{Target Rate \times NGOP}{Frame Rate} \qquad ( 15 )$$

where NGOP is the number of frames in one GOP. It is desirable to control the GOP_{bit-rate} in (2) very close to the Output_{bit-rate}, to obtain a dynamic balance in the entire GOP coding period. If the GOP_{bit-rate} is equal to Output_{bit-rate}, then

$${I}_{bit} + 3 {P}_{bit} + 8 {B}_{bit} ≅ \frac{Target Rate \times 12}{Frame Rate} \qquad ( 16 )$$

i.e. the GOP structure is contained in one I-frame, three P-frames and eight B-frames, and thus we assume that all P- and B-frames have the same coding rate. In order to achieve the dynamic balance, the coding bit-rates of B-frames are adaptively modified to compensate for those of the I- and P-frames. Since B-frames are not used as references for motion prediction, the B-frame coding is not as important as that of the I-frame and P-frames. Moreover, B-frames use the bi-directional prediction, and so their coding errors will be smaller. From (9), (13) and (16), the B-frame bit-rate is limited to

$$\frac{Targe Rate}{8 \times Frame Rate} \times ( 12 - {IR}_{L} - 3 {PR}_{L} ) \geq {B}_{bit} \geq \frac{Targe Rate}{8 \times Frame Rate} \times ( 12 - {IR}_{H} - 3 {PR}_{H} ) . \qquad ( 17 )$$

In order to control the B-frame bit-rate, its quantization level is adjusted in each Slice, which is similar to that of the P-frame coding. Meanwhile, the buffer occupation also must be monitored periodically during the P- and B-frames coding, where the control procedure is the same as that of the I-frame coding.

In order to obtain higher coding efficiency, use of Intra-coding in the same video sequence should be avoided if the temporal correlation is high, which can be done as follows. A video sequence can be partitioned into many AGOP's, and each AGOP consists of 12-frames as a coding unit that contains one enhanced P-frame (Pₑ), three P-frames and eight B-frames. The enhanced P-frame is the starting point for each AGOP. Its position is like as the I-frame of a BGOP, but its coding bit-rate is not as high as an I-frame, which is given by

$$( \frac{Target Rate}{No\_Slice \times Frame Rate} ) \times {P}_{e} {R}_{H} \geq {Slice}_{n}^{Pe} \geq ( \frac{Target Rate}{No\_Slice \times Frame Rate} ) \times {P}_{e} {R}_{L} \qquad ( 18 )$$

where PR_{H(L)}<PₑR_{H(L)}<IR_{H(L)}. Its P- and B-frame coding rates are similar to (12) and (17) respectively. The P- and B-coding bit-rate may be increased slightly to improve the coding quality since the Pₑ-frame coding rate is usually less than that the I-frame. The coding performance of the entire video sequence is then greatly improved from the motion compensation. However coding bit-rates can vary drastically for different video sequences, so it is not easy to achieve an ideal buffer occupation for each GOP coding. Hence we need to monitor the buffer status at the end of each GOP. If the buffer is occupied by one half or more at the end of the GOP coding, the coding rate should be decreased in the next GOP to achieve the coding bit-rate balance.

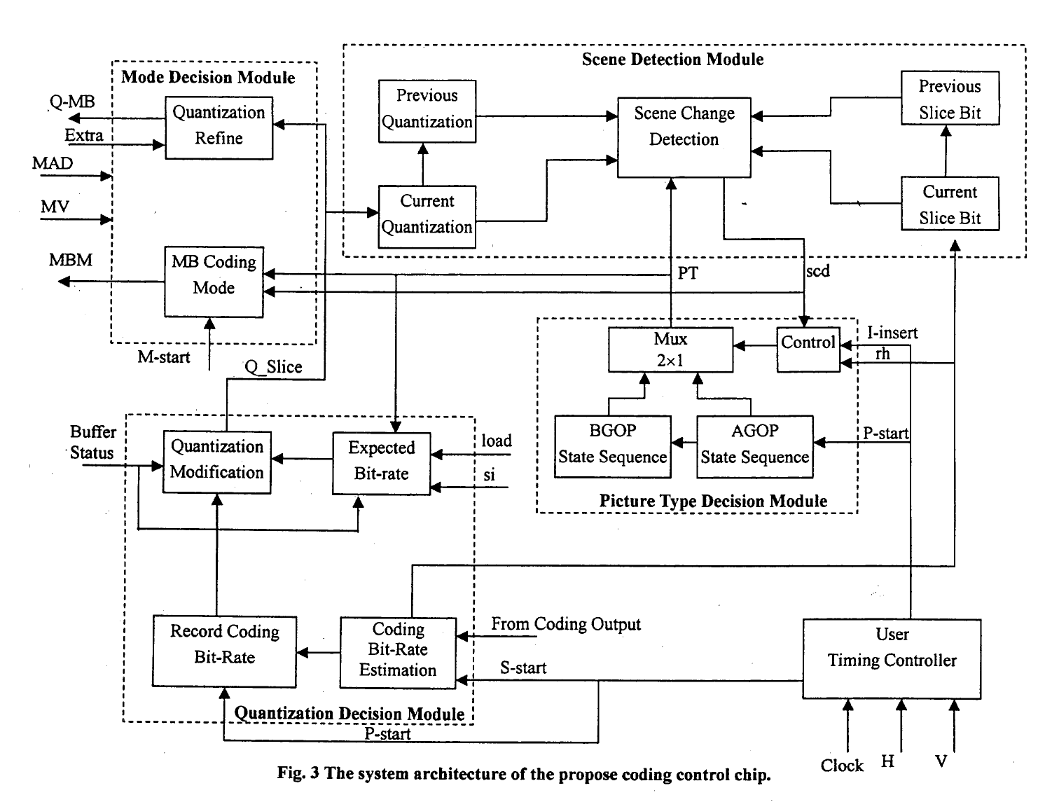

For practical purposes, the functions of scene change detection, quantization scale, and coding mode for each macro-block and picture type decisions must all built-in on a single chip. Hence we design our chip with four modular. The system architecture is illustrated in FIG. 3, and each module is described as follows.

(i) Picture Type Decision Module: This module starts in a BGOP structure. As the picture starting code (P-start), a trigger signal is received, we start coding and the I P1 B1 B2 P2 B3 B4 . . . frames are sequentially coded one-by-one. Until at the 12^{th} frame, the AGOP structure takes over. The AGOP coding structure stops if one of the three happened. (1) If a scene change is detected, i.e. the scd signal becomes high; or (2) If the coding rate for the P-frame is too large and the output rh signal becomes high; or (3) If an I-picture is inserted from the external 1-insert pin to support a flexible coding. If any one of these occurs, the AGOP coding stopped and the module returns to the BGOP coding. We employ two state-machines to generate BGOP sequence (0→1→2→3→1→2 . . . ) and AGOP sequence (5→1→2→3→1→2 . . . ). According to the occurrence of scd, rh and I-insert, the BGOP or AGOP sequence is selected to determine the frame coding.

(ii)Quantization Decision Module: The quantization scale depends on the buffer status and the current coding bit-rate. The bit-rate of each Slice is obtained from the coding result as soon as the Slice start (S-start) signal is received. This result is used for scene detection, and is accumulated to estimate the coding bit-rate. A default bit-rate of the expected slice is established for different frame types according to our simulations, where 400 k bits buffer size, 30 frames/sec and 352×288 resolution were used. As the coding specification changed, the expected bit-rate can be re-programmed from the external Si pin. If the loading pin becomes high, new parameters will be loaded into the chip sequentially. At first, the 4-bit start code used to double checking the system to ensure a reloading is necessary. The internal registers for the expected rate will be updated if the starting code is correct. The new data are then serially loaded into the registers as follows. The first portion of the data for the upper bound coding rates is: (1) a 16-bit data for the I-picture; (2) a 16-bit for the P-picture; (3) a 16-bit for the Pe-picture; and (4) a 16-bit for the B-picture. Then the lower bound rate for each frame is loaded similar to the upper bound rate in the same order. As the download is completed, we can output an expected coding bit-rate again in accordance with the picture type decision. By (8)-(18), the quantization scale is adjusted by referring to the buffer status and the comparison of the coding bit-rate and the expected rate. Finally, the quantization decision module outputs Q_slice for each slice.

(iii) Scene Change Detection Module: We need to check whether scene changes occur at P- or Pe-pictures. To do this, the bit-rate of the first N slice-bits in the previous and current frames are accumulated and recorded according to (4). Simultaneously, the quantization scales of these slices are also averaged and recorded. As a scene change is found, the output signal scd becomes high, and it will remain high until the next frame check does not satisfy (4). The scd signal is then send to the quantization decision module to change the expected bit-rate to an I-picture. At the same time, the mode decision module also received this information for changing to the I-block coding until the scd signal turns to low.

(iv) Block Mode Decision Module: This module determines the coding type by (6) and refines the quantization scale for each macro-block. As a macro-block starting code (M-start) is received, a new block matching result MAD and its motion vector Mv are updated from the motion estimation. Then a new coding mode and a quantization scale are decided according to the new MAD and MV. In order to reduce the I/O number, the MAD result is quantized into two bits in VC code, and the MV uses one bit in ZM code (whether zero-vector is found). According to (6), as VC=10 and ZM=0, there exists large difference between the current block and the referenced block after motion compensation. The coding result will produce a large bit-rate if inter-coding mode is used, so the intra mode is used instead for the current block coding. As VC=00 and ZM=1, one can apply inter (skip) mode because the current block is almost the same as the referenced one. As VC=00 and ZM=0, inter (MV only) mode is used. If none of the above applies, the inter (DCT+AMV) mode is used.

One may use the information of the buffer status to modify the coding mode and to determine the block quantization scale. The buffer status uses a 2-bit symbol by SB value, and the quantization scale uses 5-bits with Q_MB symbol according to coding standards. When QMB=0, there is no quantization in the coding mode; otherwise, quantization occurred. The block quantization scale is then refined for the local image by extra information extracted, such as, when the block appeared to have an image edge or other important information, the quantization scale is decreased by one step to improving the coding quality. In case of SB=11, the buffer utilization is over 80%, the inter (DCT+MV with quantization) mode should be used to reduce the bit-rate for Pe-, P- and B-frames. As SB=10, this means the buffer utilization is between 80%˜20%, then the coding mode follows the procedure described above. As SB=01, the buffer utilization is about 10%˜20%, then inter (DCT+MV without quantization) mode will be used again, but without quantizations. As SB=00, the buffer utilization is less than 10%, in order to avoid an underflow, the intra mode shall be used.

To reduce the full search complexity, an adaptive full search algorithm is presented with two approaches: (1) reducing the operator of MAD calculation; (2) reducing the number of block match. First, let us define the PE (processing element) as

PE=Σ|fₜ(i, j)−fₜ₋₁(i+mx, j+my)|, (19)

to discuss how to reduce the number of MAD computations. For computing one MAD value, N² PEs are used from Eq.(1). To reduce the number of PEs, a computational constraint approach is proposed as follows. While the previous n blocks have been matched, the minimum MAD (named as MMAD(n)) and its motion vector are recorded. To match the (n+1)^{th} block, the result of each PE is accumulated to MAD(n+1)^{th}. The symbol MAD(n+1)_{(i,j)}^{th}, denotes the MAD(n+1)^{th} computation has been accumulated to the (i,j)^{th} PE. Once MAD(n+1)_{(i,j)}^{th}>MMAD(n), the MAD(n+1)^{th} computing can be stopped because the MAD(n+1)_{(i,j)}^{th} is larger than MMAD(n) value. The (n+1)^{th} block is impossible to be a best match, so the residual PEs computing can be skipped to save the searching time. However, as the complete MAD(n+1)^{th} computation is finished with N² PEs, and MAD(n+1)^{th}<MMAD(n) is identified, the (n+1)^{th} block becomes the best match. Then the MAD(n) recorder should be updated by the current MAD(n+1)^{th} value and the next block is matched again.

With this computational constraint, the MAD(n+1)^{th} computation can be diminished to improve the searching speed for each block match. The PE efficiency-up-ratio (PEUR) could be achieved by

$$PEUR = \frac{{N}^{2}}{K} ,$$

where K is the total PE number used while the MAD(n+1)^{th} stop computing at the (i,j)^{th} element. Since K is often less than N², many PE computations can be saved. Hence the searching efficiency can be improved.

Next, an adaptive full-search algorithm is presented to reduce the number of block matching. The basic motivation is that since the vector difference of inter-frames is small for continuous video sequences, only the difference is needed to estimate the motion-vector in recursive searches. At first, the temporal vector distance (TVD) is defined by the vector difference between the current frame and the previous frame, which is given by

TVD=|mvₙ^{t-1}−mvₙ^{t}|={square root over ((mxₙ^{t-1}−mxₙ^{t})²+(myₙ^{t-1}−myₙ^{t}))²)}, (20)

where mvₙ^{t} and mvₙ^{t-1} denote the motion vectors of the n^{th} macro-block in the current frame t and in the previous frame t-1, respectively. The spatial vector distance (SVD) is the absolute distance between the macro-block vector and the zero-vector in the current frame. It can be written as

SVD=|mvₙ^{t}−mvₙ^{t}(0,0)|=\sqrt{(mxₙ^{t})²+(myₙ^{t})²}, (21)

where mvₙ^{t} (0,0) is a zero vector for n^{th} macro-block in the current frame. As the video sequence is continuous, most of the blocks move along the same direction between inter-frames, thus TVD<SVD is always satisfied.

When TVD<SVD is satisfied in video sequences, the motion vector of the n^{th} block in the current frame uses that of the previous frame as a reference location to reduce the searching complexity. Hence the current searching vector can be written as

mvₙ^{t}=mvₙ^{t-1}+δ(x, y), (22)

where δ(x,y) is the differential vector between the current block vector and the previous one. Since mvₙ^{t-1} has already been estimated in the previous frame, only the differential vector δ(x,y) is searched to obtain the current vector mvₙ^{t}. The differential motion vector can be estimated from

δ(x,y)=full_search(MV(0,0)=mvₙ^{t-1}). (23)

The previous vector mvₙ^{t-1} is used rather than the vector (0,0) as a central-vector of the searching window. For recursive operations, the referenced vector mvₙ^{t-1} is pre-stored in the memory and is updated after each frame processing. Then the real motion vector can be obtained from the sum of the motion vector of the previous frame and the differential vector. Therefore, the computational complexity can be greatly reduced since only the δ(x,y) is searched. With this approach, the vectors are successively accumulated from the previous vector, the final estimated vector may be beyond the original searching window limitation, hence the near-global optimum is achieved This recursive approach can attain a good performance in high motion sequences because only a smaller window for differential vector estimation can be used instead of a larger one.

It is noted that when the condition TVD<SVD is not valid, the motion vector will not be correctly estimated, not only for the current image but also for the next ones. To solve this problem, the recursive search is constrained with a block-by-block base as follows. The central-vector (CV) of the searching window is determined by

$$\{ \begin{matrix}If {MAD ( MV )}_{n}^{t - 1} \geq {MAD ( 0 , 0 )}_{n}^{t} & then CV = {( 0 , 0 )}_{n}^{t} . & ( 23 a ) \\ If {MAD ( MV )}_{n}^{t - 1} < {MAD ( 0 , 0 )}_{n}^{t} & then CV = {( MV )}_{n}^{t - 1} . & ( 23 b )\end{matrix}$$

The MAD(MV)ₙ^{t-1} and MAD(0,0)ₙ^{t} individually denote the Mean Absolute Differential (MAD) values using the motion vector of the previous frame and the zero vector of the current frame for the n^{th} macro-block. For searching the motion vector of the n^{th} block, first the MAD(MV)ₙ^{t-1} and MAD(0,0)ₙ^{t} is checked. If (23a) occurs, the condition TVD<SVD is not satisfied, the recursive search is broken since the zero vector is chosen. On the other hand, we can make sure that TVD<SVD is satisfied in (23b), then the temporal vector will be used for the recursive operation.

Because most of the sequences are stationary or quasi-stationary, all moving-vectors are possibly covered within a smaller search range as the recursive approach is used. However, the temporal vector distance may be longer in high motion pictures. To achieve high performance search for these cases, the searching window size should be dynamically expanded or condensed according to the video motion feature. Then the hierarchical layer processing can be used to determine the window size with

$$\{ \begin{matrix}If {MAD}_{min}^{k} < {Th}_{k} & Stop Searching \\ Else k = k + 2 & Next Layer Searching\end{matrix} , \qquad ( 24 )$$

where MADₘᵢₙ^{k}denotes the minimum MAD after the k layer processing, and Thₖ is the threshold in the k^{th} layer. The threshold value is different in each layer, and Th₂<Th₄<Th_{6 . . .} <Thₖare set for practical purposes. Initially, let k=2. The window-size uses layer-2 to estimate the block matching result. If MADₘᵢₙ ² is still larger than the threshold Th₂, this implies that there are probably high motion blocks, the window size is expanded to the layer-4 in order to cover the higher moving-vector. If the k^{th} layer cannot meet the desired accuracy, we continue to search the next layer until an optimal result is achieved. To constrain the computational complexity, the maximum layer is usually limited in practice. In general, the number of processing layer is dependent on motion features of video sequences. A high motion block naturally requires higher layer processing to cover the possible vector, so the relative complexity becomes higher.

From FIG. 1, the processing layer-2, layer4 and layer-6 need to search 25, 81 and 169 candidates, respectively. If the maximum layer uses 6, the total block matching number (TBMN) of the proposed method is

TBMN_{proposed}=25×L2N+81×L4N+169×L6N, (25)

wherein the L2N, L4N and L6N denote the summation of using layer-2, layer-4 and layer-6 as the block matching. However, the TBMN for the conventional full search is

$${TBMN}_{full} = ( \frac{M \times N}{16 \times 16} ) \times {( 2 W + 1 )}^{2} \times frame \# no \qquad ( 26 )$$

where M and N represent the frame size, and the W is the window size. For comparison of the computational complexity, let us define a speed-up-ratio (SUR) as

$$SUR = \frac{{TBMN}_{Full}}{{TBMN}_{propose}} . \qquad ( 27 )$$

While this recursive full search and the hierarchical processing scheme consists of the MAD computation constraint, the searching efficiency can be further promoted. The searching efficiency (SE) can be evaluated by

SE=SUR×PEUR. (28)

Since SUR>1 and PEUR>1, the efficiency of the proposed adaptive full search should be higher than the conventional full search.

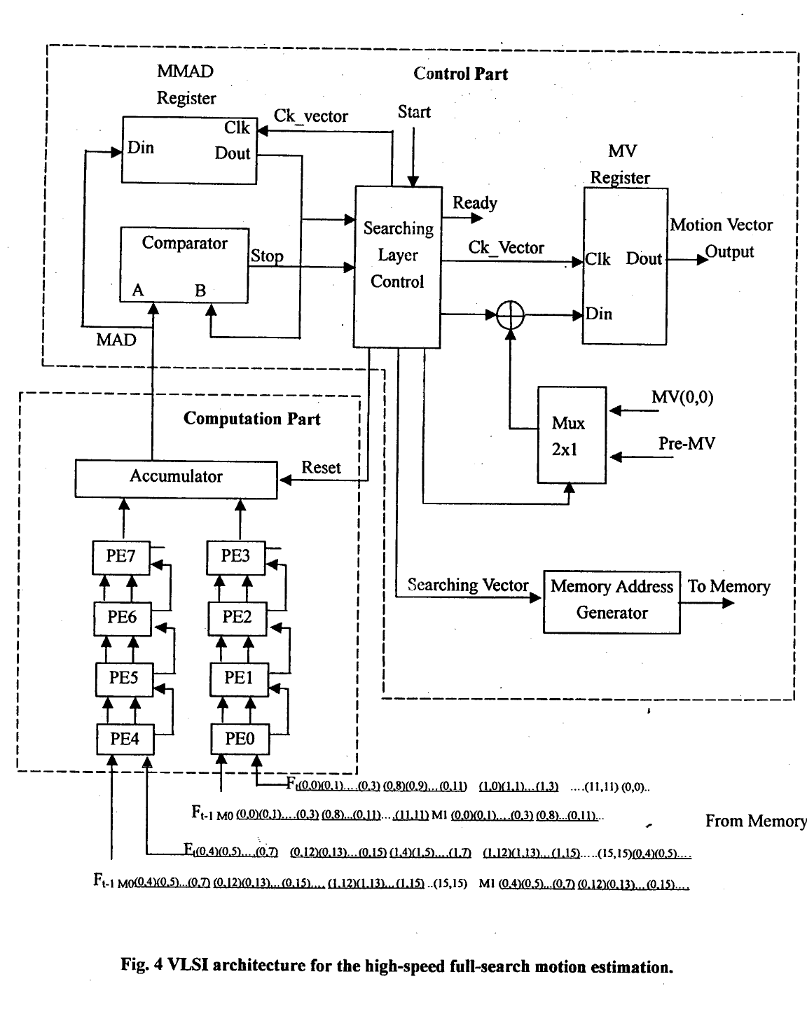

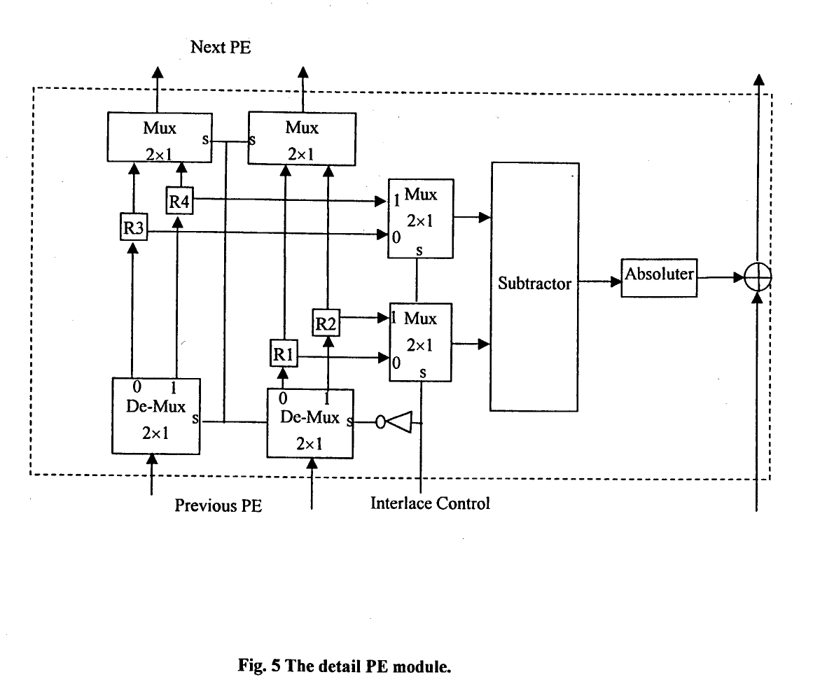

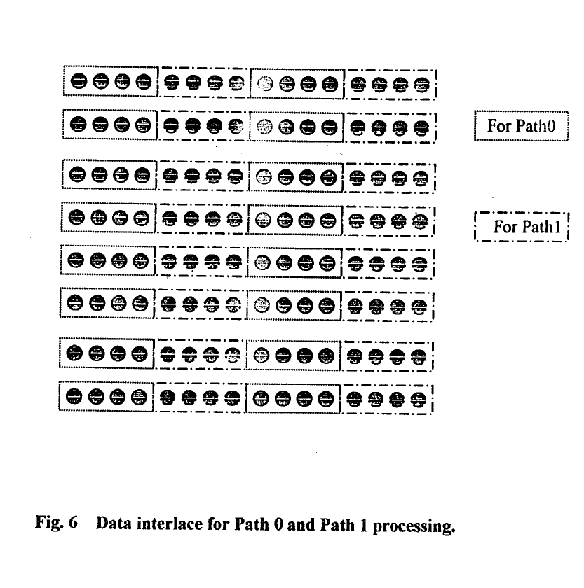

Based on the adaptive full search algorithm, an ASIC chip is developed for the motion estimation to meet the throughput of MPEG-II coding. For considering a regular design, the number of PE uses 8 in our VLSI architecture. FIG. 4 illustrates the proposed VLSI architecture for a high-efficiency full-search motion estimation. With the interlace processing, the PE computational kernel has two paths. Each path contains four PEs, one is PE0˜PE3 and the other is PE4˜PE7. The design of a PE module is shown in FIG. 5 that contains R1˜R4 registers and Mux/De-Mux to control data access. The input block data is partitioned for the interlace processing, which is shown in FIG. 6.

As the interlace control pin is low in the PE module, R1 and R3 data of each PE input to the subtractor. In the path 0, the sum of |Fₜ(0,0)−Fₜ₋₁(0,0)|, |Fₜ(0,1)−Fₜ₋₁(0,1)|, |Fₜ(0,2)−Fₜ₋₁(0,2)| and |Fₜ(0,3)−Fₜ₋₁(0,3)| is performed in the 1^{st} time, where Fₜ and Fₜ₋₁ are the current frame and the previous frame, respectively. At the same time, the sum of |Fₜ(0,4)−Fₜ₋₁(0,4)|, |Fₜ(0,5)−Fₜ₋₁(0,5)|, |Fₜ(0,6)−Fₜ₋₁(0,6)| and |Fₜ(0,7)−Fₜ₋₁(0,7)| is also got from the path1. During this computing time, the next data Fₜ(0,8)˜(0,15) and Fₜ₋₁(0,8)˜(0,15) are loaded to R2 and R4 of each PE in the path 0 and path 1, respectively. So the clock time of shift-registers is ¼ of the computing time. During the 2^{nd} time, Fₜ(0,8)˜(0,15) and Fₜ₋₁(0,8)˜(0,15) from R2 and R4 of each PE input to subtractors in the path 0 and path 1 since the control pin for interlaced selection becomes high. Thus the sum of |Fₜ(0,8)−Fₜ₋₁(0,8)| to |Fₜ(0,15)−Fₜ₋₁(0,15)| is computed for the second time. Simultaneously, the next data Fₜ(1,0)˜(1,7) and Fₜ₋₁(1,0)˜(0,7) are loaded to R1 and R3 in this time.

The control core in FIG. 4 performs the computational constraint and the hierarchical layer processing with the recursive vector. The start signal controls the searching loop into an initial state that the accumulator is reset to zero and MMAD register is set to a maximum value. The MMAD register stores the minimum MAD for searching the best block match. As the searching process goes on, the current MAD is accumulated to the accumulator in each cycle. The current MAD value (not complete) is compared with the MMAD register in each cycle. Once the stop signal becomes high from the comparator, the current MAD computing can be exited in any cycle. Then the searching layer controller sends the next searching vector to the memory address generator to read the memory data for the next block match. However, the new best block match is found if the stop signal is still low at the N²/8 clocks, which implies that the current MAD is smaller than MMAD. Thus the controller sends the “CK_Vector” command to update the MMAD register and the MV register with the current MAD value and its motion vector. Because the hierarchical layer is employed in this system, the searching time is not fixed. Thus a “ready” pin is required to notice the user as the block vector is found. The hierarchical layer control depends on the MMAD value. As the MMAD value is smaller than the Th2, the search is stopped in the layer 2 for the current block. Otherwise, the next layer vector is searched until the accuracy achieves an optimal result. For the recursive vector generation, the searching control determines the central vector of the searching window using the zero vector MV(0,0) or the previous frame vector Pre-MV If the recursive operation is used, the output motion vector can be computed from the sum of the current vector and the Pre-MV value. Because the recursive vector is performed, the vector value possibly becomes more and more large as the coding procedure goes on. Considering the I/O complexity, only 8 pins are used to cover ±127 vectors for high motion sequences.

What is claimed is:

1. An MPEG-II video encoder chip design method includes algorithms and VLSI architectures for video coding control and motion estimation in video coding systems.

2. The MPEG-II video encoder chip design method using an adaptive GOP structure for video coding control. GOP length is various.

3. The MPEG-II video encoder chip design method as claimed in claim 2, wherein the GOP (group of picture) structure consists of a group of picture.

4. The MPEG-II video encoder chip design method as claimed in claim 2, wherein the GOP structure is dependent on the inter-frame correlation; when the intervening frames have high correlation, the coding scheme uses more prediction coding to reduce the temporal redundancy until the accumulated error becomes too large or a scene change is detected.

5. The MPEG-II video encoder chip design method as claimed in claim 4, wherein the inter-frame correlation denotes the difference from the current frame to the reference frame.

6. The MPEG-II video encoder chip design method as claimed in claim 1, wherein the scene detection checks the coding rate and quantization scale from the first N slices of current and previous frames from Eq. (4), where N is not fixed; as scene change is found, I-mode is used to code the next slices until to the first N slices of the next frames, as shown in FIG. 1.

7. The MPEG-II video encoder chip design method as claimed in claim 6, wherein the coding mode is immediately decided from the detection result, without re-encoding procedures.

8. An adaptive GOP structure containing a basic GOP and a plurality of advanced-GOPs, as shown in FIG. 2; both basic GOP and advanced-GOP use 12 or 15 frames as a coding unit.

9. The adaptive GOP structure as claimed in claim 8, wherein the advanced-GOP have one enhanced P-frame, three normal P-frames and 8 B-frames, no I-frame is use; the bit rate of enhanced P-frame is higher than normal P-frame.

10. The adaptive GOP structure as claimed in claim 9, wherein the AGOP coding scheme ends when a scene change is detected or the accumulated error becomes too large, and the coding procedure then begins another BGOP processing.

11. The adaptive GOP structure as claimed in claim 10, wherein the block coding mode is determined by MAD values and motion vector from motion estimation result with Eq. (6).

12. The adaptive GOP structure as claimed in claim 10, wherein the frames in AGOP uses I-block coding for local area when block temporal difference is large.

13. The adaptive GOP structure as claimed in claim 8, wherein buffer rate control is monitored by coding slice and buffer status, then determining the quanzation scale in Eq. (9)-(14); the current slice and buffer status independently determines the quantization of the next slice with one and two levels respectively.

14. The adaptive GOP structure as claimed in claim 1, wherein the coding bit rate balance decided from the coding rate of I and P frames, and then use B-frame rate to compensate that of I and P frames to achieve balance during one GOP coding period in Eq. (17).

15. The adaptive GOP structure as claimed in claim 1, wherein the position of Pe frame of an AGOP is like as the I-frame of a BGOP, but its coding bit-rate is not as high as an I-frame; the bit rates of P and B frames in the AGOP are higher than that of BGOP.

16. An MPEG-II video encoder chip design method for real-time coding control system architecture as shown in FIG. 3; the four modular are scene change detection, quantization scale, and coding mode for each macro-block and picture type decisions.

17. The MPEG-II video encoder chip design method as claimed in claim 16, wherein the control parameter is programmable for various resolutions; the data can download to the chip via serial port for the upper and low bound to default various coding frames. Reading the current coding bit rate and motion estimation result, and then computations for changing the quantization level if the bit rate does not meet the expected rate. The quantization level can be modified with extra pin.

18. The MPEG-II video encoder chip design method as claimed in claim 16, wherein the scene detection module determines whether the current frame is scene change using the averaged quanization of the previous N slice and its coding rate compared to that of the current frame; the result sends to the modular of picture type decision.

19. The MPEG-II video encoder chip design method as claimed in claim 17, wherein the picture type is implemented by state machine for BGOP and AGOP structure. Once scene change is found or the bit rate of P frames is too high, or extra I-frame insertion, then AGOP ending and BGOP starting.

20. A coding mode of macro-block modular, wherein MAD information of motion estimation being quantized with two bit VC code, and one bit ZM code for zero vector checking; the coding block mode is decided with VC and ZM information.

21. A quantization scaling modular using the coding bit-rate of Slice for determining the quantizarion level of the next Slice; each block quantization level being refined according to the Slice quantization value.

22. The adaptive GOP structure as claimed in claim 13, wherein the buffer state is classified with 2 bits (SB) to four levels in over 80%, under 10%, 10%˜20% and normal 20%˜80% occupations, then to determine the block mode and quantization scale. Inter mode (DCT+MV+quantization) is used in over 80%. Between 80%˜20%, the coding mode follows the procedure described above. As SB=01, in 10%˜20% utilization, then inter (DCT+MV without quantization) mode without quantizations is used. The intra mode shall be used in under 10% utilization.

23. A motion estimation with a new algorithm and architecture.

24. A recursive motion estimation algorithm used the motion vector of the previous frame as a center point of searching window; by checking MAD value using Eq. (23), the recursive search being broken if the temporal correlation becomes low MAD is Mean Absolute Difference of the current block and reference block.

25. The recursive motion estimation algorithm as claimed in claim 24, wherein the range of motion vector can cover the entire frame. The result is a globe optimization.

26. The recursive motion estimation algorithm as claimed in claim 24, wherein the number of searching point is adaptive according to frame correlation. If the correlation is high, the number of block matching number is reduced.

27. The recursive motion estimation algorithm as claimed in claim 24, wherien th temporal correlation is defined in the same claim 5.

28. A recursive full search and the hierarchical processing scheme consisting of the MAD computation constraint to promote the searching efficiency.

29. The recursive full search and the hierarchical processing scheme as claimed in claim 28, wherein the hierarchical processing denotes the window size is changeable.

30. A system architecture as claimed in claim in FIG. 4; the computational kernel used 8 processing elements (PE), and partition to two paths, each path has 4 PE. But the PE number is not limited in 4. The inter-connection of PE operates likes shift register.

31. The system architecture as claimed in claim 30, wherein the searching layer control determines the block matching number and whether recursive vector used, and generate the searching vector, from the MAD and MMAD results.

32. The system architecture as claimed in claim 30, wherein the current MAD is accumulated to the accumulator in each cycle; the current MAD value is compared with the MMAD register in each cycle; once the stop signal becomes high, the current MAD computing can be exited in any cycle. Then the searching layer controller sends the next searching vector for checking again.

33. A detail PE as shown FIG. 5 with one subtraction and absolution; the interlace control scheme is used to access register by multiplex and de-multiplex control.

34. The detail PE as claimed in claim 33, wherein the PE operates with shift register for data transferring; the serial register clock is 4 times as that of accumulator.

35. The detail PE as claimed in claim 30, wherein the memory access used interlace scheme, input data is partitioned 4 pixels as a unit. The data used path0 and path1 for PE0˜3 and PE4˜7 respectively, as shown in FIG. 6. But the path and PE number is not limited.
